(19) United States
(12) Patent Application Publication
(10) Pub. No.: US 2006/0262802 A1
(43) Pub. Date: Nov. 23, 2006

(54) Ethernet repeater with local link status that reflects the status of the entire link

(76) Inventor: Greg A. Martin, Lisle, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/133,758

(22) Filed: May 20, 2005

(51) Int. Cl. H04L 12/413; H04L 12/56; H04L 12/28

(52) U.S. Cl. 370/401

(57) ABSTRACT

An exemplary Ethernet repeater includes an Ethernet driver module adapted to terminate a first Ethernet link and generate repeated Ethernet signals on a second Ethernet link. The Ethernet driver module is adapted to detect whether the second Ethernet link is up and provides control information coupled to the first Ethernet link where the control information is sensed by an Ethernet source connected to the other end of the first Ethernet link. A control circuit is coupled to the Ethernet driver and adapted to generate the control information in response to a signal from the terminal of the driver module to which the Ethernet link status indicator is connected.

### BACKGROUND

This invention relates to wired Ethernet communications and more specifically relates to extending the distance of an Ethernet link by using an Ethernet repeater.

Ethernet communication links are widely used in the telecommunication and computer industries. For example, personal computers typically provide one or more Ethernet ports that include a standard RJ-45 jack for connection with an Ethernet cable. The Ethernet port may be used to establish communications with an Ethernet router that supports a local area network, a cable or DSL modem, or any external device configured to support Ethernet communications.

The maximum length of cable which may be utilized for reliable communications between two Ethernet devices will vary. Under near optimal conditions a cable of 100 meters or greater may be utilized while still maintaining reliable communications. However, impedance mismatches between terminating devices or other interfaces in series with the Ethernet link will restrict the length of cable that can be utilized while maintaining reliable communications. This impairment is in addition to the normally expected resistance and/or impedance effects of the cable itself.

An Ethernet repeater consists of an active device, i.e. an amplifier, that can be connected in series with an Ethernet cable/link and regenerates the bidirectional signals so that a longer Ethernet cable may be utilized on the link served by the repeater. However, by inserting an active device in series with the Ethernet link, what was a single link is now divided into two sub links, i.e. a near link (nearer the Ethernet source) and a far or distal link at a remote source or device. A visible link status indicator, e.g. typically a green LED, may be provided by the Ethernet source for users at the near end. However, the actual status of the entire Ethernet link consisting of the far end and the near end segments may not be accurately reflected by the status indicator at the near end where the repeater is not managed by the far end. That is, the far end link may be down (not currently supporting communications) while the near end status indicator indicates that the link is up (communications currently supported). Although the near end link may be up, this causes the user at the near end to erroneously assume that the entire Ethernet link is up. Thus, there exists a need for an improved Ethernet repeater that can provide the user at the near end with link status information that accurately reflects the communication status of the entire link.

### SUMMARY

It is an object of the present invention to satisfy this need.

An exemplary Ethernet repeater includes an Ethernet driver module adapted to terminate a first Ethernet link and generate repeated Ethernet signals on a second Ethernet link. The Ethernet driver module is adapted to detect whether the second Ethernet link is up and provides control information coupled to the first Ethernet link where the control information is sensed by an Ethernet source connected to the other end of the first Ethernet link. A control circuit is coupled to the Ethernet driver and adapted to generate the control information in response to a signal from the terminal of the driver module to which the Ethernet link status indicator is connected.

### DESCRIPTION OF THE DRAWINGS

Features of exemplary implementations of the invention will become apparent from the description, the claims, and the accompanying drawings in which:

FIG. 1 is a block diagram of an exemplary prior art implementation of a basic Ethernet link.

FIG. 2 is a block diagram of an exemplary embodiment of an Ethernet repeater in accordance with the present invention.

### DETAILED DESCRIPTION

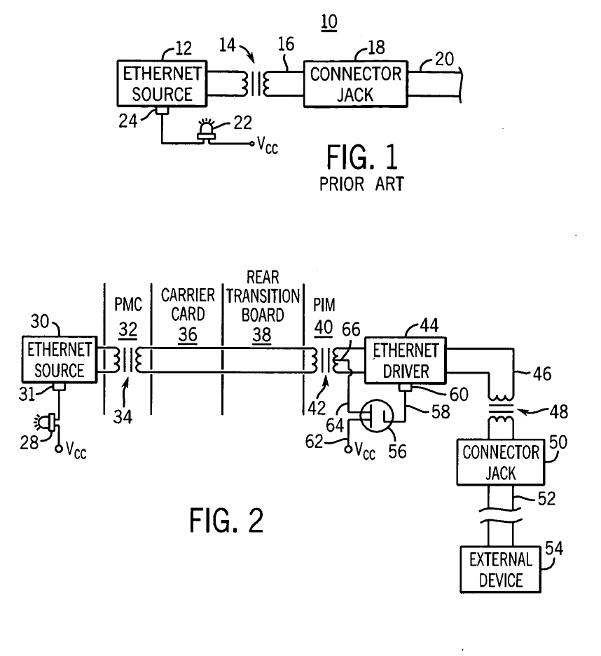

FIG. 1 illustrates a conventional Ethernet link 10 that includes an Ethernet source 12 such as an Ethernet router that may be connected to a local area network. The Ethernet wire connection from Ethernet source 12 is coupled by transformer 14 and a length of cable 16 to a connector jack 18 that may comprise a conventional RJ-45 receptacle adapted to receive a mating jack that will connect an external device (not shown) to the Ethernet link by a cable 20. The Ethernet source 12 has an LED 22 with one lead connected to a pin or terminal 24 and the other lead connected to supply voltage Vcc such that when the link is up, the LED is illuminated due to the pin 24 sinking current. Such a configuration may be present in telecommunication equipment, e.g. a rack of telecommunication cards, as well as in a variety of other electronic equipment in which an Ethernet connection is to be provided to an end-user or external peripheral equipment. The cumulative length of cables 16 and 20 must be limited such that the signals transmitted from and received by the equipment connected to cable 20 and Ethernet source 12 are sufficiently strong and undistorted to be reliable. Reflections of the signals caused by less than perfect terminations and impedance changes adversely impact the transmission of the desired signals and hence limit the total cable length that can be utilized.

FIG. 2 is a block diagram of an illustrative embodiment of an Ethernet link in accordance with the present invention which incorporates an Ethernet repeater. The embodiment of the present invention is especially, but not exclusively, adapted to provide improved driving capability at the distal end of an Ethernet link where an intermediate portion of the link adversely impacts the Ethernet signals in terms of driving ability of a distal cable and where management and/or control of a distal repeater, e.g. control of a link status indicator to include the status of the distal repeater, is not provided by the Ethernet source or intermediate devices. An Ethernet source 30, such as a router connected to a local area network, provides an Ethernet origination that serves as the beginning of an Ethernet link with a plurality of elements connected in series. In the illustrated embodiment the elements of the Ethernet link may be contained within a rack of telecommunication equipment. The Ethernet source 30 has a status indicator, e.g. an LED, 28 with one lead connected to a pin or terminal 31 and the other lead connected to supply voltage Vcc such that when the link is up, the LED is illuminated due to the pin 31 sinking current.

A PCI mezzanine card (PMC) 32, supported by a communications apparatus (not shown), is coupled to the Ethernet source 30 and includes a transformer 34 that couples the Ethernet link to a carrier card 36. The carrier card may contain a microprocessor controller and memory to perform call processing functions. The PMC mezzanine card is used to augment the functionality of the carrier card by adding additional Ethernet interfaces above and beyond that which is provided by the carrier card. For the purpose of clarity in focusing on aspects of the present invention, the various conventional cards and modules that comprise the Ethernet link are illustrated as separated segments of the link. The Ethernet link continues from the carrier card 36 to a rear transition board 38 of the telecommunication equipment. The link is then coupled by transformer 42 to a PMC interface module (PIM) 40 that includes an Ethernet driver 44. This driver terminates the Ethernet link with Ethernet source 30 and originates a repeater link, i.e. a distal link that replicates transmitted and received signals from the link associated with Ethernet source 30. The repeater link is coupled to cable 46 and through transformer 48 to connector jack 50 which consists of an RJ-45 jack disposed on a user accessible panel associated with the telecommunication equipment. An external cable 52 plugged into the jack 50 completes the Ethernet repeater (distal) link with an external device 54.

The Ethernet driver 44 may consist of a commonly available Ethernet router module/chip such as a Marvell 88E6083 Ethernet switch for a 4 port extender with only one port extension being shown. The Ethernet driver 44 includes a terminal 60 controlled by internal circuitry to sink current, i.e. provide a path to the voltage reference (ground), when the Ethernet link to the external device 54 is sensed to be up. An active device 56, e.g. a field effect transistor, has its control terminal 58 (gate) connected to terminal 60. One terminal of device 56 (the drain of the FET) is connected to a DC voltage source Vcc. The other terminal of device 56 (the source of the FET) is connected to a center tap connection 66 of the winding of transformer 42 coupled to Ethernet driver 44. When terminal 60 sinks current, the active device 56 is turned ON thereby applying the voltage source to the center tap 66 which is required for the operation of the Ethernet link to the Ethernet source 30. This also causes the LED 28 connected to Ethernet source 30 to emit light and hence provide an indication that the entire Ethernet link is up. Conversely when terminal 60 does not sink current, the voltage source is not applied to the center tap 66 of transformer 42 thereby causing the Ethernet driver 44 to be unable to repeat Ethernet signals. This condition is sensed by the internal control circuitry of the Ethernet source 30 which will cause its terminal 31 not to sink current. This causes current to the LED indicator 28 to cease thereby causing it to turn OFF. Having voltage supplied to the center tap is a condition precedent (but not sufficient by itself) to the internal circuitry of the Ethernet source determining that the link is up.

In a known conventional use of such an Ethernet driver 44, the center tap 66 of transformer 42 would be permanently connected to a DC voltage source, i.e. voltage would be continually applied to the center tap, when used in a repeater function. This would cause the internal link status sensing circuitry of the Ethernet source 30 to assume that the link between the Ethernet driver 44 and Ethernet source 30 was always up, and control terminal 31 to always sink current thereby causing the LED 28 to be always ON. Hence, the end-user upon observing the LED 28 in a conventional configuration could be misled into thinking that entirety of the Ethernet link was up when the link between the Ethernet driver 44 and the external device 54 was down.

The internal status sensing circuitry of Ethernet driver 44 periodically, e.g. every few seconds, tests to determine if an active link status, i.e. the link is up, to the external device 54. When the link is determined to be up, voltage is applied to the center tap 66 of transformer 42 causing drive voltage to be applied to the Ethernet driver 44 and hence enabling it to establish link conductivity with Ethernet source 30. The internal control circuitry of the internet driver 44 will cause terminal 60 to continue sinking current until it senses that communication connectivity with the external device 54 has been lost. When such a loss is sensed, terminal 60 will cease sinking current thereby causing the voltage source to be removed from the center tap 66 causing the link to the Ethernet source 30 to be dropped hence LED 28 will be turned off indicating a link down condition.

The Ethernet repeater link in accordance with an embodiment of the present invention provides a link status indication that reflects the status of the entire link. An end-user at the near link can rely on the link status indication as an indication of the status of the entire link, including the link status of the repeater link portion.

Although exemplary implementations of the invention have been depicted and described in detail herein, it will be apparent to those skilled in the art that various modifications, additions, substitutions, and the like can be made without departing from the spirit of the invention. For example, active device 56 may comprise any type of device capable of switching based on a control signal. The link indication device 28 may comprise any type of visual or audio indicator suited for providing link status information directly or indirectly to the end-user. The Ethernet driver 44 may comprise any module/chip that operates to provide functionality of a single Ethernet repeater or may comprise a single module/chip with integrated functionality to provide a plurality of Ethernet repeaters, e.g. a 4 or 8 port device. It will be apparent to those skilled in the art that the Ethernet repeater of the present invention can be utilized to enhance the maximum usable length of cable 52 independent of the specific devices, structure and cables of the intermediate link portion between the repeater and the Ethernet source. Although device 56 applied a DC voltage to the center tap of a transformer associated with the Ethernet driver 44, a switching apparatus serving the function of device 56 could be used to provide a source of voltage (source current) or provide a return voltage path (current sink) for the Ethernet driver or circuitry associated therewith to cause the link status indicator to reflect the status of the entire link. As an alternative to the external device 56, the Ethernet driver 44 could be designed to internally contain the functionality provided by device 56.

The scope of the invention is defined in the following claims.

I claim:

1. An Ethernet repeater comprising:
an Ethernet driver module adapted to terminate a first Ethernet link and generate repeated Ethernet signals on a second Ethernet link;
the Ethernet driver module adapted to detect whether the second Ethernet link is up and having a terminal that provides a signal representing whether the second Ethernet link is up;
the Ethernet driver module being coupled to the first Ethernet link that comprises an intermediate link and an Ethernet source that includes a link status indicator;
means for generating control information based on the signal from the terminal causing the Ethernet link status indicator at the Ethernet source to reflect the link status of a path through both the first and second links.

2. The Ethernet repeater of claim 1 wherein the generating means comprises a switching device with a control input coupled to the terminal and a first output coupled to the Ethernet driver module.

3. The Ethernet repeater of claim 2 wherein the switching device includes a second output coupled to one of a voltage source and a voltage return path, the second output being selectively coupled to the first output based on control provided by the terminal as coupled to the control input.

4. The Ethernet repeater of claim 3 wherein the switching device comprises a transistor.

5. The Ethernet repeater of claim 1 further comprising a transformer having a center tapped winding where each end of the winding is coupled to the Ethernet driver module and couples Ethernet signals of the first Ethernet link to the Ethernet driver module.

6. The Ethernet repeater of claim 5 wherein the generating means comprises an output that is coupled to the center tap of the winding of the transformer.

7. The Ethernet repeater of claim 6 wherein the generating means selectively couples a source voltage to the output to feed the center tap of the transformer based on the input from the terminal.

8. The Ethernet repeater of claim 7 wherein the Ethernet source is responsive to whether voltage is applied to the center tap and causes the Ethernet link status indicator at the Ethernet source to be dependent on whether voltage is applied to the center tap, whereby the Ethernet repeater generates control information causing the Ethernet link status indicator at the Ethernet source to reflect the status of the combination of the first and second links.

9. An extended Ethernet link comprising:
an Ethernet source that includes a link status indicator;
a first Ethernet link coupled to the Ethernet source;
an Ethernet repeater coupled to the first Ethernet link;
the Ethernet repeater including:
an Ethernet driver module adapted to terminate the first Ethernet link and generate repeated Ethernet signals on a second Ethernet link;
the Ethernet driver module adapted to detect whether the second Ethernet link is up and having a terminal that provides a signal representing whether the second Ethernet link is up;
the Ethernet driver module being coupled to the first Ethernet link;
circuit having an input connected to the terminal and an output that provides control information based on the signal from the terminal causing the Ethernet link status indicator at the Ethernet source to reflect the link status of a path through both the first and second links.

10. The extended Ethernet link of claim 9 wherein the circuit comprises a switching device with a control input coupled to the terminal and a first output coupled to the Ethernet driver module.

11. The extended Ethernet link of claim 10 wherein the switching device includes a second output coupled to one of a voltage source and a voltage return path, the second output being selectively coupled to the first output based on control provided by the terminal as coupled to the control input.

12. The extended Ethernet link of claim 11 wherein the switching device comprises a transistor.

13. The extended Ethernet link of claim 9 further comprising a transformer having a center tapped winding where each end of the winding is coupled to the Ethernet driver module and couples Ethernet signals of the first Ethernet link to the Ethernet driver module.

14. The extended Ethernet link of claim 13 wherein the output of the circuit is coupled to the center tap of the winding of the transformer.

15. The extended Ethernet link of claim 14 wherein the circuit selectively couples a source voltage to the output to feed the center tap of the transformer based on the input from the terminal.

16. The extended Ethernet link of claim 15 wherein the Ethernet link status indicator of the Ethernet source is indirectly controlled by the signal of the terminal.
